(19) United States
(12) Patent Application Publication
(10) Pub. No.: US 2004/0049440 A1
(43) Pub. Date: Mar. 11, 2004

(54) Real estate appraisal auxiliary system, a storage medium with a computer software program stored therein for use by a computer system to assist in appraising real estate, and a real estate appraisal auxiliary method

(76) Inventors: Masahiro Shinoda, Tokyo (JP); Kenji Sakemi, Tokyo (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/241,323

(22) Filed: Sep. 11, 2002

(51) Int. Cl. G06F 17/60

(52) U.S. Cl. 705/35

(57) ABSTRACT

This real estate appraisal auxiliary system and the like comprise a map database storing unit for storing a map database comprised by relating land value information and urban planning drawing information on a plurality of locations with their position coordinates on a map, a use zoning obtaining unit for obtaining the use zoning of a location to be appraised from the urban planning drawing information if the location to be appraised has been specified on a map, a land value information retrieving unit for retrieving land value information comparable with the location to be appraised based on the use zoning obtained by the use zoning obtaining unit, and a standard land value calculation unit for calculating a standard land value for the location to be appraised based on the land value information retrieved by the land value information retrieving unit.

### BACKGROUND OF THE INVENTION

1. Field of the Invention

The present invention relates to a real estate appraisal auxiliary system and the like for providing a real estate value calculation service, for example, on the Internet.

2. Description of the Related Art

In general, a specialist or an appraiser carefully examines land value information such as cases of transactions in the past, publicly-assessed land values, land value investigations, publicly-assessed street facing land value and the like, and analyzes a location to be appraised in reference to the aforesaid land value information to thereby derive the land value of the location to be appraised.

In order to do this, such land value information must be collected in advance and the appraiser must determine whether or not each piece of land value information is comparable with the location to be appraised.

However, data of the publicly-assessed land value, the land value investigation and the like must be stored for at least several years in order to learn the transition history thereof, and therefore, the data grows to an enormous volume. In addition, it takes a long time to investigate all of the data. Moreover, it is a time-consuming and painstaking task to collect and retrieve the land value information.

In order to address the above-mentioned problems, inventions to automate real estate appraisal have been devised as disclosed in the Patent Gazette for JP-2505142.

The invention disclosed in the above Patent Gazette is “a land value appraisal method, comprising the steps of storing in a storage means in advance, land value information on a plurality of locations in relation to their position coordinates on a map, displaying a location to be appraised on a display screen, if the location to be appraised is specified on a map displayed on the display screen, searching for an appropriate number of the nearest locations to the location to be appraised from the plurality of locations, displaying positions and land value information for searched nearest locations as nearest location information for position coordinates corresponding to the nearest locations, storing a mathematical expression in advance for taking account of land value information of the appropriate number of the nearest locations, determining a land value of the location to be appraised based on a result calculated with the mathematical expression, and displaying the land value of the location to be appraised on the display screen.”

According to this method, an appropriate number of the nearest locations can be retrieved using a criterion “being close to the location to be appraised based on a distance from the location to be appraised” to thereby derive the land value of the location to be appraised based on this land value information.

However, if the land value information is collected based solely on the distance from the location to be appraised, land value information with different use zonings may be retrieved, and in that case, the reliability of the calculated land value will be considerably compromised. In addition, although the use zoning can be narrowed down in advance, if there is only a limited number of locations with the same use zoning available in the vicinity of the location to be appraised, the land value information will be retrieved from substantially more distant locations, and the appraisal reliability will remain low.

Also, real estate values have high individuality in general. For example, locations within the same area may have very different values depending on the geography, size, contact surface situation and the like. Therefore, a system according to the aforementioned patent invention will require its user's expertise to determine the individuality of real estate in the system and ultimately derive the value of the location to be appraised. This will lead to user limitation and, if the user has insufficient expertise, poor appraisal reliability as well.

### SUMMARY OF THE INVENTION

Considering the above-mentioned situation, the purpose of the present invention is to provide a real estate appraisal auxiliary system which can provide highly reliable appraisal services.

In order to achieve the aforesaid objective, according to a first principal aspect of the present invention, there is provided a real estate appraisal auxiliary system, comprising a map database storing means for storing a map database comprised by relating land value information and urban planning drawing information on a plurality of locations with their position coordinates on a map, a use zoning obtaining means for obtaining the use zoning of a location to be appraised from the aforesaid urban planning drawing information if the aforesaid location to be appraised has been specified on a map, a land value information retrieving means for retrieving land value information comparable with the aforesaid location to be appraised based on the use zoning obtained by the aforesaid use zoning obtaining means, and a standard land value calculation means for calculating a standard land value for the aforesaid location to be appraised based on the land value information retrieved by the aforesaid land value information retrieving means.

According to this configuration, the use zoning is obtained automatically by specifying an arbitrary location on the aforesaid map. Therefore, based on the use zoning, appropriate land value information can be retrieved to thereby calculate a highly reliable standard land value. Note that an output from this invention is simply a standard land value, that is a land value benchmark, and not a value directly calculated for real estate with high individuality. As a result, it becomes possible to provide a versatile and highly reliable service.

Incidentally, it is desirable that this system further comprises a publicly-assessed street facing land value obtaining means for obtaining, based on the aforesaid location to be appraised specified by a user, the publicly-assessed street facing land value of the streets with which the location at issue is in contact, and that the aforesaid land value information retrieving means retrieves, in reference to the aforesaid publicly-assessed street facing land value, only the land value information which differs from the aforesaid publicly-assessed street facing land value is within a predetermined range. According to this configuration, highly comparable land value information can be retrieved based on the publicly-assessed street facing land value of the location to be appraised.

Also, it is desirable that the aforesaid land value information retrieving means retrieves only the land value information within a predetermined range in reference to the aforesaid location to be appraised. In this case, it is more desirable that the aforesaid land value information retrieving means retrieves the land value information within a wider range than the aforesaid predetermined range in reference to the location to be appraised if the number of locations with land value information obtained from the predetermined range is less than or equal to a predetermined number.

According to this configuration, highly comparable land value information can be retrieved by retrieving land value information within a predetermined range. Since this predetermined range will be enlarged when there is an insufficient number of locations with land value information retrieved, the number of locations with land value information retrieved can be maintained above or equal to a certain level.

Further, it is desirable that the aforesaid land value information retrieving means searches land value information for a plurality of use zonings to be searched including the use zoning obtained by the aforesaid use zoning obtaining means, and retrieves the aforesaid land value information that is associated with respective use zonings. According to this configuration, a search can be performed for a plurality of use zonings appropriately specified as land value information for calculating a land value of the location to be appraised. Thus, the number of locations with land value information retrieved can be maintained above or equal to a certain level even when there is insufficient land value information with the same use zoning in the vicinity.

Also in this case, it is preferable that the aforesaid land value information retrieving means displays the retrieved land value information according to use zoning, and that the aforesaid land value information retrieving means displays only the land value information obtained by the aforesaid use zoning obtaining means if the number of locations with land value information retrieved is greater than or equal to a predetermined number. According to this configuration, the user convenience improves since land value information with the same use zoning as the use zoning of the location to be appraised is displayed by a higher priority than land value information with other use zonings. In addition, there is provided an effect of preventing more than enough amount of land value information from being displayed.

Moreover, it is desirable that the aforesaid standard land value calculation means of this system calculates a standard land value for the location to be appraised by using land value information selected by the user from the land value information retrieved by the aforesaid land value information retrieving means. According to this configuration, only the land value information determined by the user to be suited as land value information is selected for calculating the land value. Thus, unselected land value information can be excluded, and the reliability of land value calculation will improve.

In addition, it is desirable that this system further comprises a calculation means transmission means for transferring the standard land value calculated by the standard land value calculation means and information on the location to be appraised, and transmitting to the user a calculation means for the user to enter individual information to thereby calculate the value of the real estate at issue. According to this configuration, it is possible to have the user perform an appraisal outside of this system at his/her own risk for real estate with strong individuality. Thus, there is provided an effect to maintain the objectivity and the reliability of a service using this system.

In addition, according to a second principal aspect of the present invention, there is provided a storage medium with a computer software program stored therein for use by a computer system to assist in appraising a real estate, wherein the aforesaid software program comprises a map database storing means for storing a map database comprised by relating land value information and urban planning drawing information on a plurality of locations with their position coordinates on a map, a use zoning obtaining means for obtaining the use zoning of a location to be appraised from the aforesaid urban planning drawing information if the aforesaid location to be appraised has been specified on a map, a land value information retrieving means for retrieving land value information comparable with the aforesaid location to be appraised based on the use zoning obtained by the aforesaid use zoning obtaining means, and a standard land value calculation means for calculating a standard land value for the aforesaid location to be appraised based on the land value information retrieved by the aforesaid land value information retrieving means.

According to this configuration, a similar effect to that of the real estate appraisal auxiliary system according to the aforesaid first principal aspect can be attained.

Further, according to a third principal aspect of the present invention, there is provided a real estate land value appraisal auxiliary method, comprising the steps of obtaining the use zoning of a location to be appraised from the aforesaid urban planning drawing information if the aforesaid location to be appraised has been specified on a map database comprised by relating land value information and urban planning drawing information on a plurality of locations with their position coordinates on a map, retrieving land value information comparable with the aforesaid location to be appraised based on the use zoning obtained by the aforesaid step of obtaining the use zoning, and calculating a standard land value for the aforesaid location to be appraised based on the land value information retrieved by the aforesaid step of retrieving land value information.

According to this configuration, a similar effect to that of the real estate appraisal auxiliary system according to the aforesaid first principal aspect can be attained.

Other characteristics and marked effects of the present invention will become apparent upon referring to explanations of the following specification when taken in conjunction with the accompanying drawings.

### BRIEF DESCRIPTION OF THE DRAWINGS

FIG. 1 is a schematic structural view showing one embodiment of the present invention;

FIG. 2 is a function block diagram showing a real estate appraisal auxiliary system;

FIG. 3 is a diagram showing a use zoning to be searched specification table;

FIG. 4 is a diagram showing a self-appraisal program;

FIG. 5 is a diagram showing the same self-appraisal program;

FIG. 6 is a flowchart showing an example of this system's operation;

FIG. 7 is a flowchart showing a land value information retrieving procedure;

FIG. 8 is a diagram showing an example of a screen for specifying a map display range;

FIG. 9 is a diagram showing an example of a map display;

FIG. 10 is a diagram showing a land value calculation location;

FIG. 11 is a diagram showing a use zoning obtaining result screen;

FIG. 12 is a diagram showing an example of a retrieving result screen of land value information;

FIG. 13 is a diagram showing a calculation result screen of a standard land value;

FIG. 14 is a diagram showing an example of a standard land value appraisal table;

FIG. 15 is a diagram showing another example of a standard land value appraisal table; and

FIG. 16 is a diagram showing yet another example of a standard land value appraisal table.

### DETAILED DESCRIPTION OF THE PREFERRED EMBODIMENT

Embodiments of the present invention will be described below based on the accompanying drawings.

(Basic Configuration)

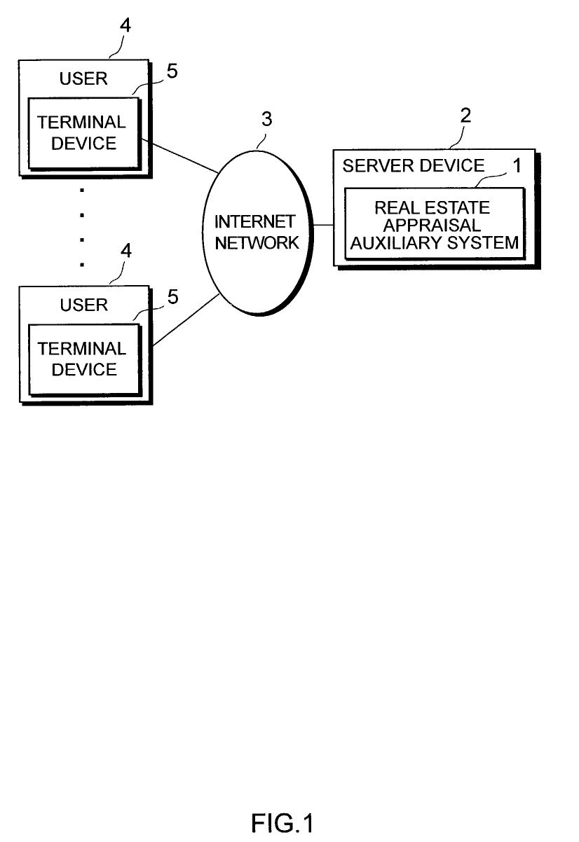

A real estate appraisal auxiliary system 1 according to one embodiment of the present invention, as shown in FIG. 1, is provided in a server device 2 at a real estate appraisal service provider, connected to the Internet network 3, and configured to be able to exchange information with a terminal device 5 (for example, a personal computer) of a user 4. This system 1 is configured to process a request of an online real estate appraisal auxiliary service from the user 4 through the terminal device 5 according to contents of the request.

FIG. 1 is a block diagram showing this real estate appraisal auxiliary system 1.

As shown in this diagram, this system is defined by connecting a bus 14, which is comprised by connecting a CPU 10, a RAM 11, an input device 12, a modem 13 and the like, with a data storage unit 15 and a program storage unit 16.

(Data Storage Unit)

The data storage unit 15 stores therein a map database 19 comprised by relating land value information 17 and urban planning information 18, a use zoning to be searched specification table 20 referred to determine a use zoning used when searching for comparable land value information, a land value detail information database 21 for storing detailed information on each piece of land value information, and a self-appraisal program 22 for the user to perform a self-appraisal.

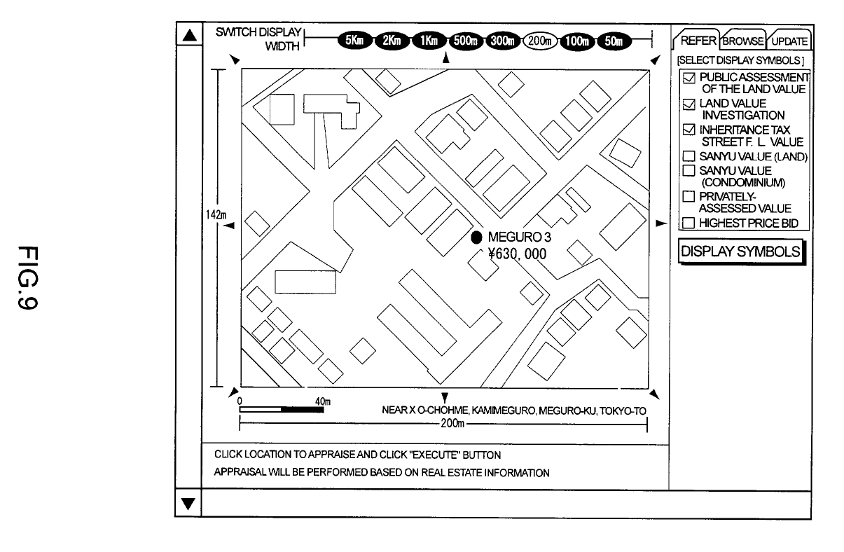

Specifically, the aforesaid map database 19 is configured to be able to assign position coordinates to the aforesaid land value information 17 and the aforesaid urban planning information 18, and display the land value information 17 and the urban planning information 18 superimposed on a residential map (See FIG. 9). This residential map comprises a plurality of hierarchies for a display according to a predetermined scale.

On the other hand, the land value information 17 consists of the publicly-assessed land value information, the land value investigation data, the privately-assessed evaluation data, and the data on the highest price bid. This publicly-assessed land value information, land value investigation data, privately-assessed evaluation data, and data on the highest price bid include at least the position coordinate and a location number for each location.

Further, the urban planning information 18 comprises the use zoning (Type one exclusively low-rise residential zone, commercial zone and other zoning types) on the aforesaid map, use zoning boundary position data (boundary position coordinates of the use zoning), and property data such as a building-to-land ratio and a floor-to-area ratio.

Also, the land value detailed information database 21 stores detailed information such as a location number, a date of value estimate, a value, a use zoning, a building-to-land ratio, a floor-to-area ratio and a distance from a train station for each location included in the aforesaid land value information 17. The location number of this land value detailed information database 21 is associated with the location number in the aforesaid land value information 17. Therefore, by specifying a specific location on the residential map, detailed information in this land value detailed information database 21 can be referenced via the aforesaid location number.

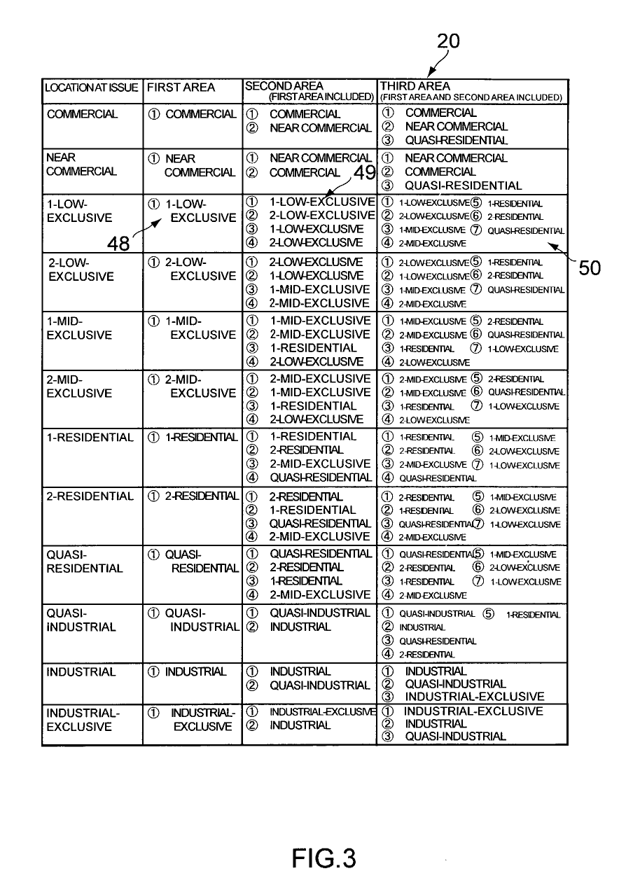

Moreover, the use zoning to be searched specification table 20, as shown in FIG. 3 for example, is a table to refer to when determining land value information to be searched. That is, in this example, if the use zoning of the location to be appraised is “commercial”, “1. commercial”, “1. commercial; 2. near commercial”, and “1. commercial; 2. near commercial; 3. quasi-residential” will be selected as a first area, a second area, and a third area to be searched, respectively.

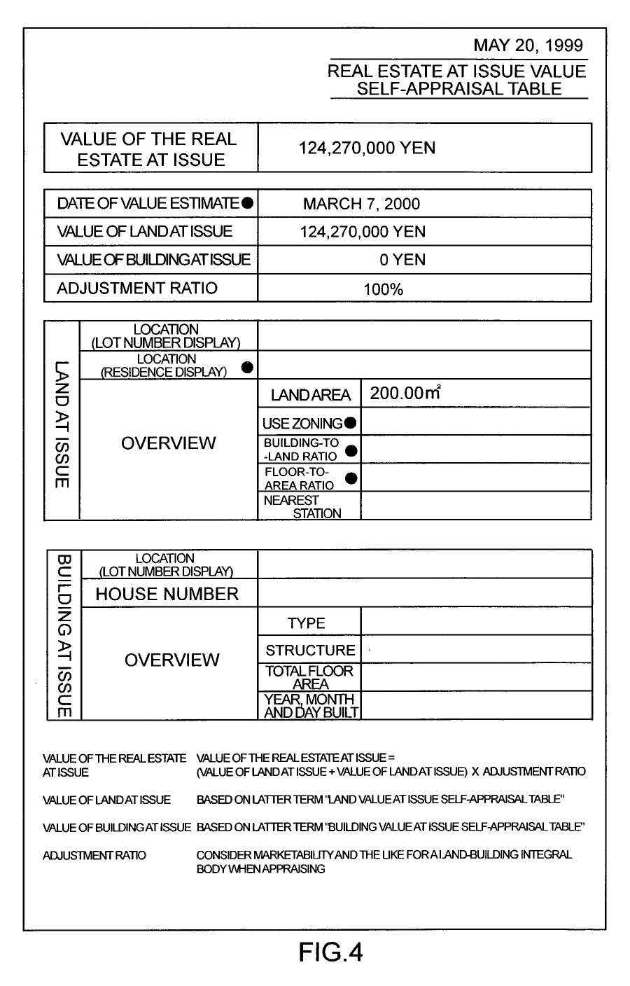

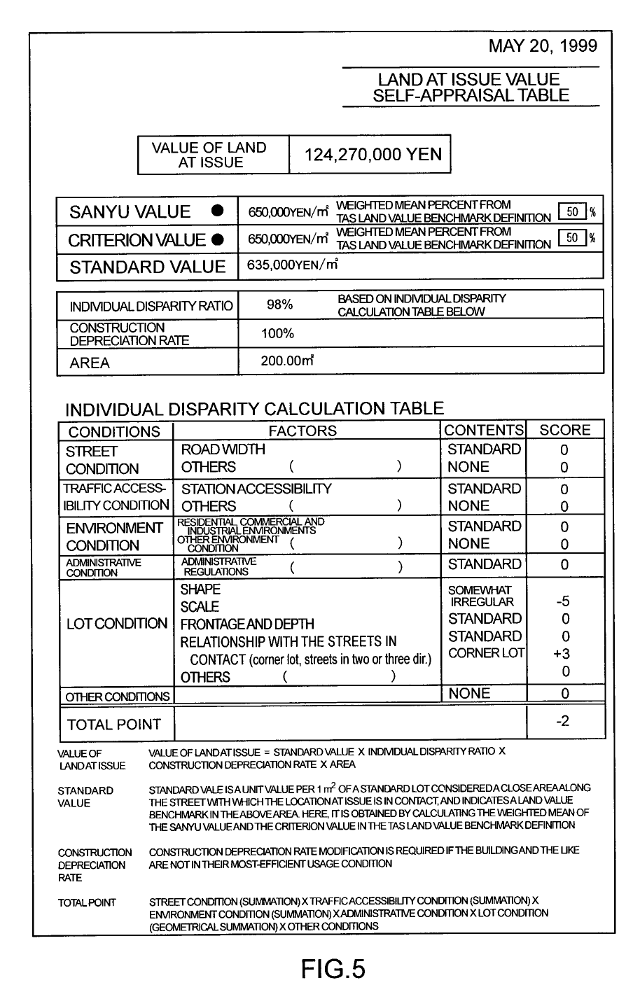

Also the self-appraisal program 22, transmitted to the user, is specifically a spreadsheet program similar to those shown in FIG. 4 and FIG. 5. Embedded in advance in this spreadsheet program are the standard land value obtained by this system and the property information of the location to be appraised (fields indicated by solid circles), and if the user enters the other individual information, a self-appraisal may be performed for the location to be appraised. Functions of this self-appraisal program will be explained in more detail below.

(Program Storage Unit)

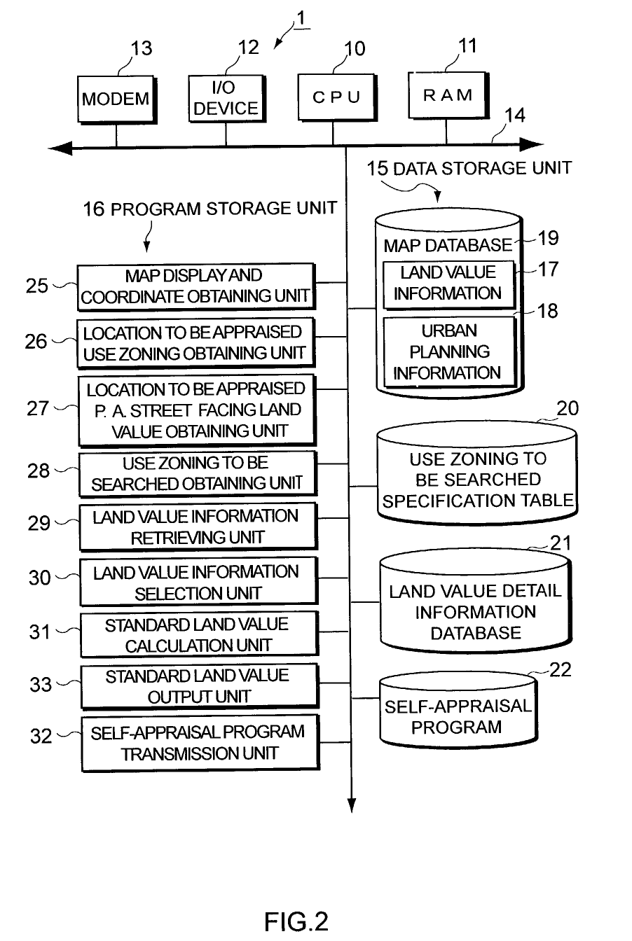

Meanwhile, as shown in FIG. 2, the aforesaid program storage unit 16 stores therein, other than a main program which is not illustrated, a map search and display unit 25, a use zoning obtaining unit 26, a publicly-assessed street facing land value obtaining means 27 for streets with which the location to be appraised is in contact, a use zoning to be searched obtaining unit 28, a land value information retrieving unit 29, a land value information selection unit 30, a standard land value calculation unit 31, a standard land value output unit 33, and a self-appraisal program transmission unit 32.

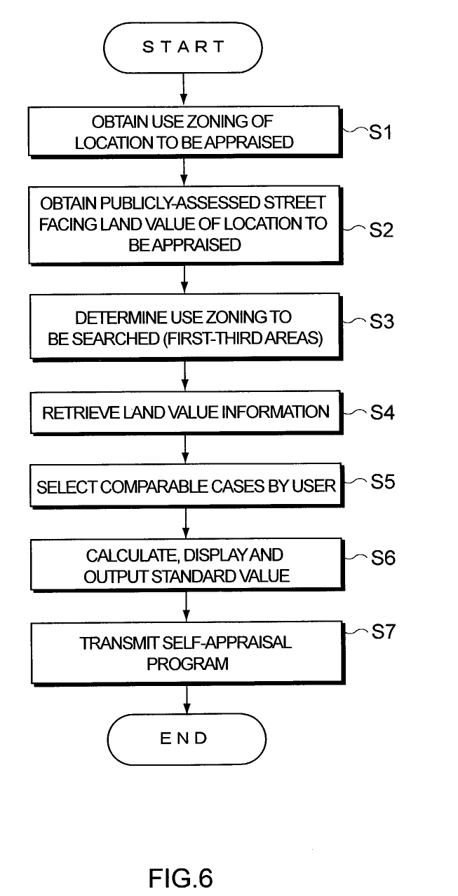

These components in fact consist of a plurality of programs and/or subroutines, and are called on the RAM and executed by the aforesaid CPU. Functions and operations of these components will be described below in detail in accordance with flowcharts shown in FIG. 6-FIG. 8 and screen display examples shown in FIG. 9-FIG. 16.

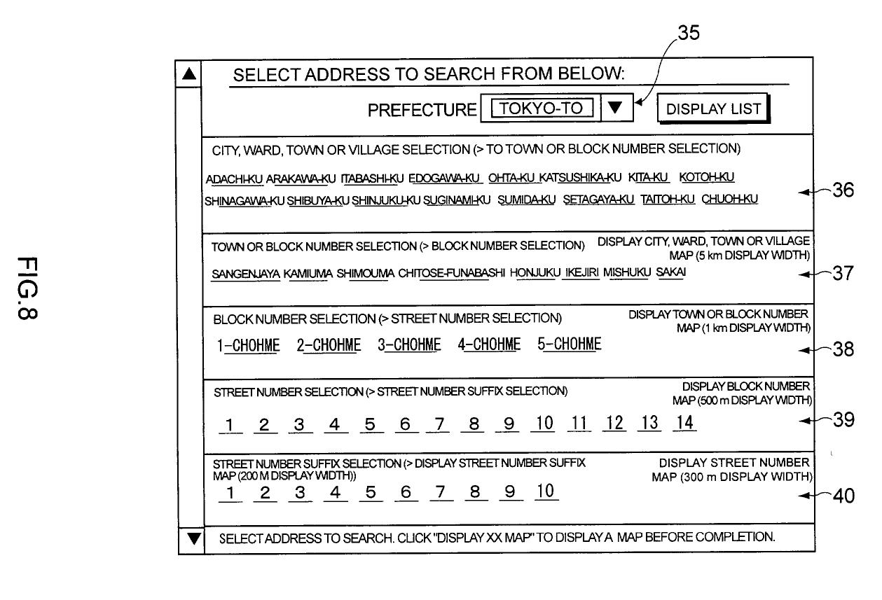

First, the aforesaid map search and display unit 25 has a function to search the aforesaid map database 19 for the residential map based on the user's specification, and transmit and display a residential map retrieved by the search after reformatting the residential map displayable on the terminal device 5 (a browser therein) of the user 4. A map range to be displayed (or searched) can be specified using, for example, “address”, “station name” and “landmark object (a hospital and the like)”. Of these, FIG. 8 indicates a screen example using the “address” in a search on the map database. In this screen, by specifying a prefecture (“todohfuken”) 35, a city, a town, or a village (“shichohson”) 36, a town or a block number (“cho-chohme”) 37, a block number (“chohme”) 38, a street number (“banchi”) 39 and a street number suffix (“goh”) 40, a map database with a scale according to a specified degree of detail is retrieved from the aforesaid data storage unit 15, and displayed as shown in FIG. 9.

On this map screen, if the user specifies a location to be appraised using a mouse and the like, a coordinate of the location to be appraised is obtained. Displaying the residential map, obtaining a coordinate of the residential map, and the like for the location at issue are in fact performed by the aforesaid map search and display unit 25 transmitting a map display program such as a JAVA (TM) applet to the user's terminal and executing the map display program on the user's terminal.

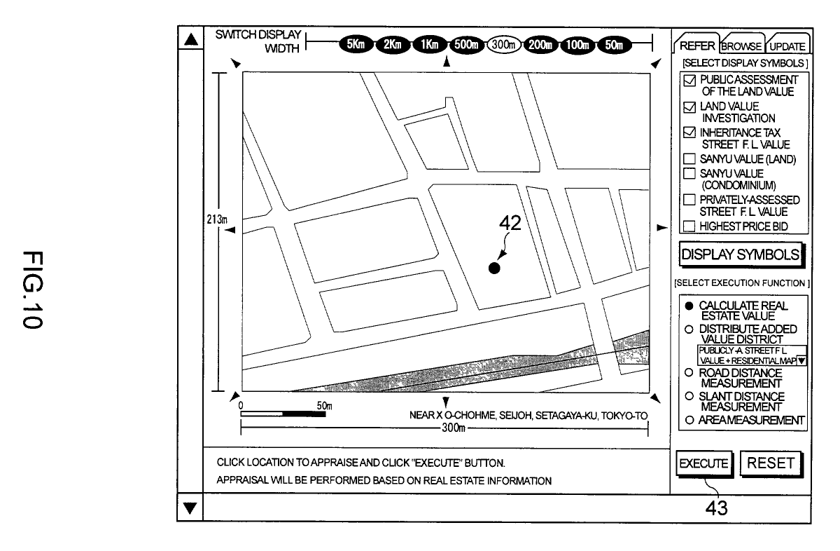

FIG. 10 is an example of a confirmation screen for a real estate appraisal execution. On this map, a solid circle location 42 is the location to be appraised specified by using the mouse and the like. Press an execution button 43 when starting a real estate calculation process by this program for this location to be appraised. If this execution button 43 is pressed, real estate value calculation processes (S1-S7) shown in FIG. 6 are executed. These calculation processes will be described below.

Once these processes are started, first, the aforesaid use zoning obtaining unit 26 obtains the use zoning of the location to be appraised based on the coordinate of the location to be appraised on the map obtained by the aforesaid map search and display unit 25 (Step S1). Specifically, the map search and display unit 25 accesses the urban planning information associated with the aforesaid map database to thereby obtain the use zoning and its property of the location at issue.

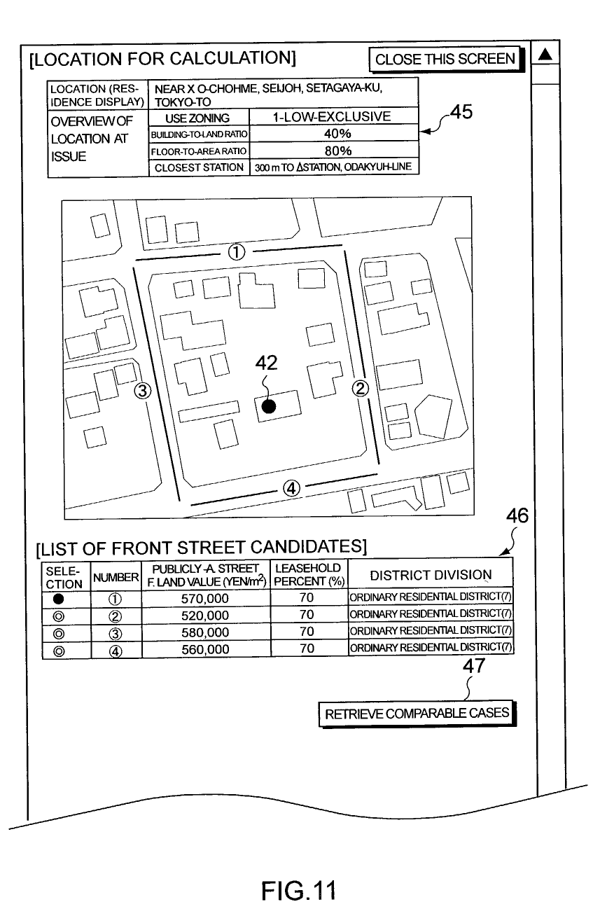

FIG. 11 is a screen indicating an execution result of the Step S1. In this example, the aforesaid location to be appraised is “X O-chohme, Seijoh, Setagaya-ku, Tokyo” as indicated with the key 45 in the diagram. Its use zoning is “Type one exclusively low-rise residential zone”, and its property is “building-to-land ratio: 40%; floor-to-area ratio: 80%; and closest station: about 300 m to Δ Station”.

Next, the publicly-assessed street facing land value obtaining means 27 obtains the publicly-assessed street facing land value for the aforesaid location to be appraised from the aforesaid land value information 17 based on the coordinate obtained by the aforesaid map search and display unit 25 (Step S2 in FIG. 6). In the example of FIG. 11, the street land value is obtained for each of streets 1-4, which are considered to be in contact with the aforesaid location to be appraised 42, and displayed in the fields indicated with key 46 in the diagram.

Meanwhile, the use zoning to be searched obtaining unit 28 applies the use zoning of the aforesaid location to be appraised, obtained by the aforesaid use zoning obtaining unit 26, to the aforesaid use zoning to be searched specification table 20 to thereby determine a plurality of use zonings to be searched (Step S3). For example, if the use zoning of the aforesaid location to be appraised is Type one exclusively low-rise residential zone (1-low-exclusive), use zonings to be searched are 1. 1-low-exclusive as the “first area” 48, 1. 1-low-exclusive; 2. 2-low-exclusive; 3. 1-mid-exclusive; 4. 2-mid-exclusive as the “second area” 49, 1. 1-low-exclusive; 2. 2-low-exclusive; 3. 1-mid-exclusive; 4. 2-mid-exclusive; 5. 1-residential; 6. 2-residential; 7. quasi-residential, respectively, as shown in FIG. 3. Determination of this use zoning to be searched is performed in order to maintain the number of locations with land value information retrieved above or equal to a certain number as described below.

Next, the aforesaid land value information retrieving unit 29 retrieves land value information from the aforesaid land value detail information database 21 based on the publicly-assessed street facing land value obtained by the aforesaid publicly-assessed street facing land value obtaining means 27, and the use zoning to be searched and the like determined by the aforesaid use zoning to be searched obtaining unit 28. Specifically, in the screen shown in FIG. 11, the following procedures are performed by the user himself/herself selecting and checking off the publicly-assessed street facing land value which is considered appropriate as a criterion for retrieving comparison examples, and pressing a land value information retrieving button 47.

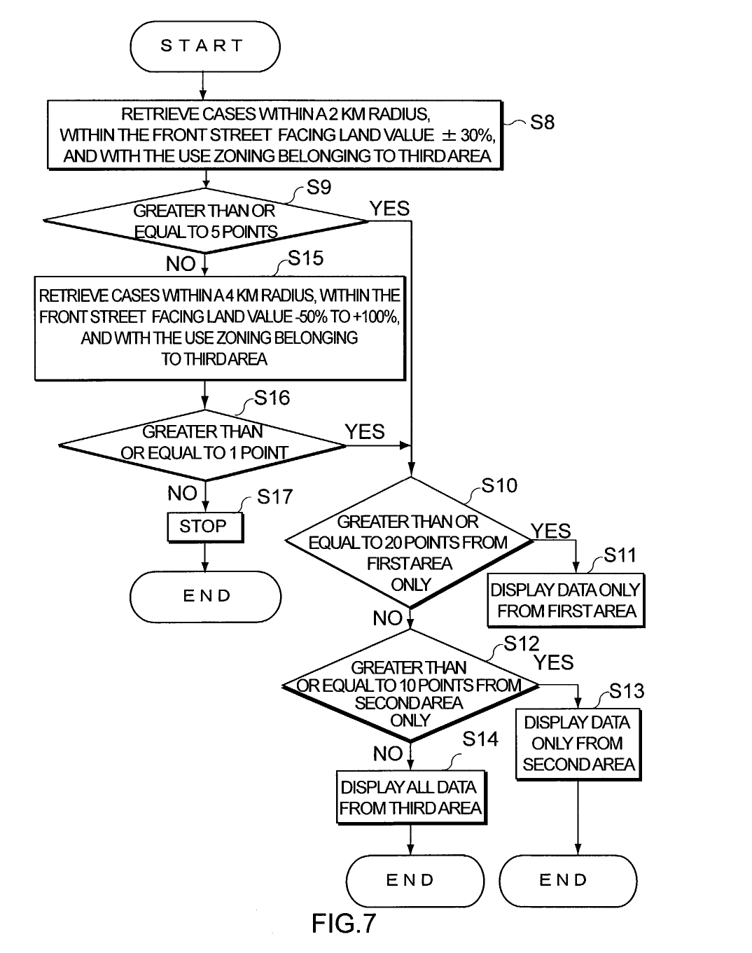

FIG. 7 is a flowchart showing a retrieving procedure of this land value information.

After this land value information retrieving procedure is started, first, by Step S8, land value information within a 2 km radius from the location to be appraised, within the front street value±30%, and with the use zoning belonging to the aforesaid the first area is retrieved from the aforesaid land value detail information database 21. If the number of locations with land value information retrieved is greater than or equal to 5 (Step S9), whether or not the number of the retrieved locations is greater than or equal to 20 solely in the first area is determined (Step S10), and if so, only land value information from the first area is displayed (Step S11).

Meanwhile, if the number of locations with land value information retrieved is less than 20 for the first area only, it is determined if the number of locations with land value information retrieved is greater than or equal to 10 for the second area (Step S12); if greater than or equal to 10 locations are retrieved, only the land value information of the second area is displayed (Step S13). Meanwhile, if less than 10 locations were retrieved from the second area, all of the land value information of the third area is displayed (Step S14).

Meanwhile, if it is determined that the number of locations retrieved in the third area is less than 5 in the aforesaid Step S9, a search range is enlarged to 4 km radius in Step S15, and another search is performed with exclusion of land value information which is above an upper limit by greater than or equal to 100%, and land value information which is below a lower limit by less than or equal to 50%, respectively. If land value information from one or more locations is retrieved (Step S16), the aforesaid Step S10-Step S14 are executed. However, the search is terminated if less than one location is retrieved (Step S17).

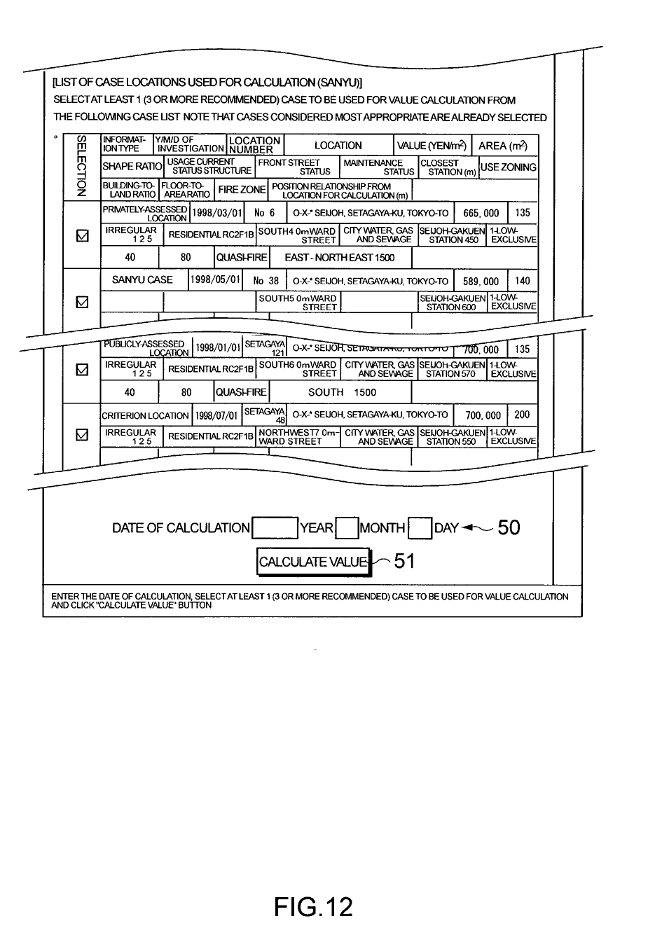

Land value information searched with this process is displayed in a screen shown in FIG. 12. According to this process, it is possible to determine an appropriate plurality number of use zonings as land value information for calculating a value of a location to be searched, and search for these use zonings. Thus, even when there is insufficient land value information with the same use zoning in the vicinity, more than enough number of locations with land value information can be easily maintained. Also, the user convenience improves since land value information with the same use zoning as the use zoning of the location to be appraised is displayed with a high priority. In addition, there is provided an effect of preventing more than enough amount of land value information from being displayed.

Next, the user freely selects land value information to be used for calculating a standard land value from the displayed land value information, enters a date of this land value calculation in fields indicated with the key 50 in the diagram, and then enters a land value calculation execution button 51 to thereby have the aforesaid standard land value calculation unit 31 calculate a standard land value for the location to be appraised based on the selected land value information. The standard land value is specifically computed as follows: “Standard Land Value=Value of Land Value Data×Time Correction Factor×Publicly-Assessed Street Value Ratio.”

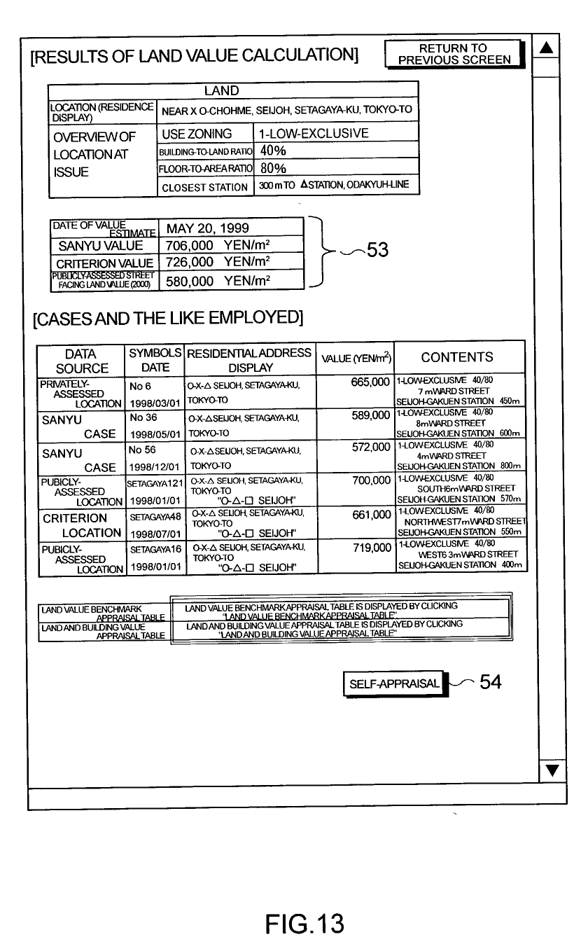

This calculation result is indicated with the key 53 in FIG. 13.

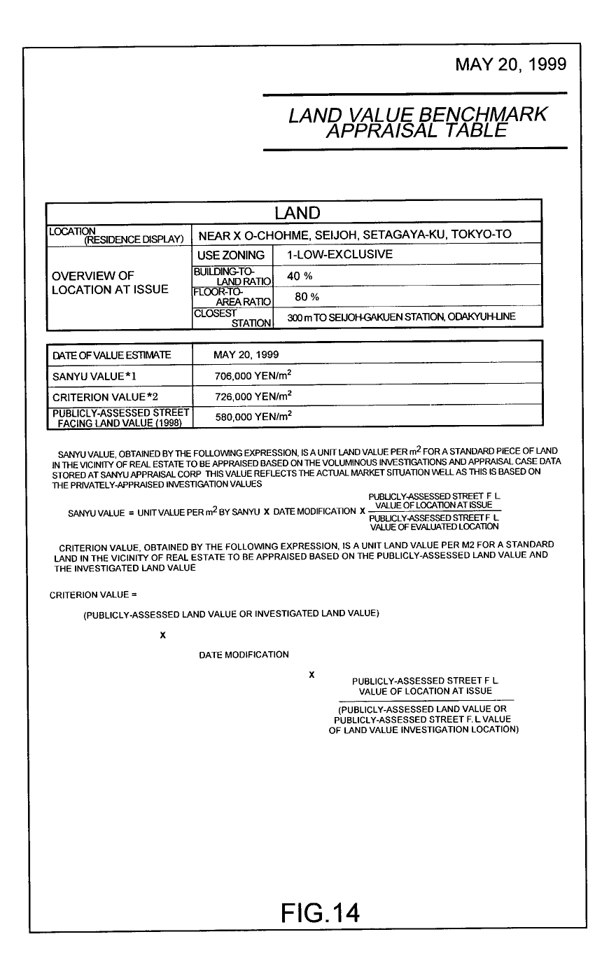

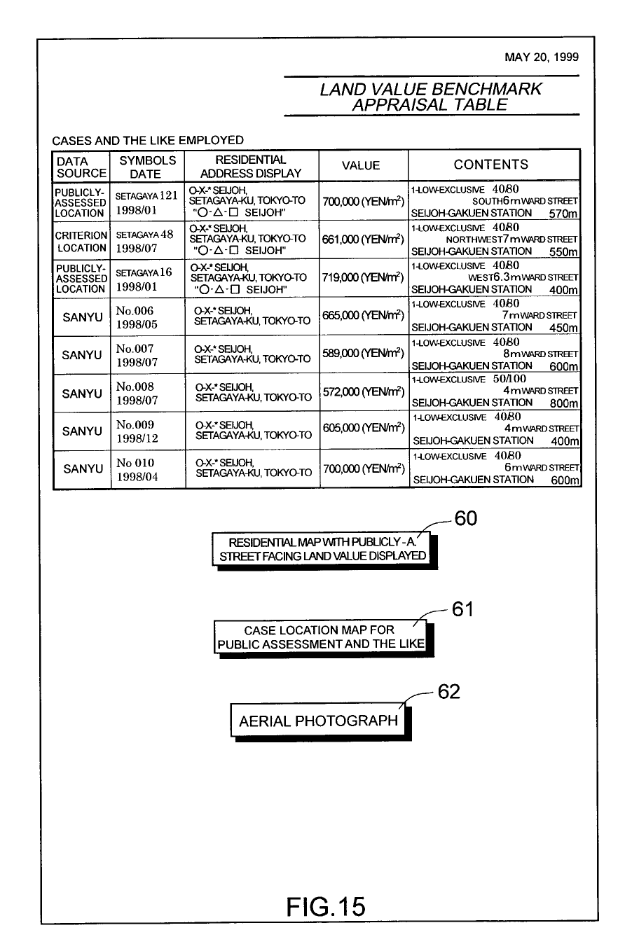

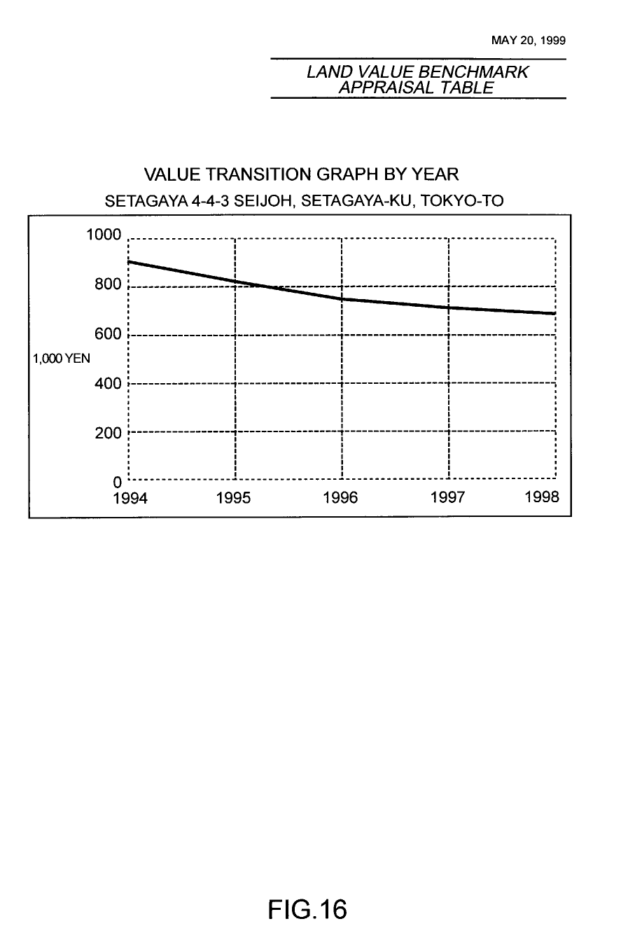

Also, this calculation result is output by the aforesaid standard land value output unit 33 as shown in FIG. 14, FIG. 15 and FIG. 16. Particularly, this standard land value output unit 33 displays the residential map of an area to be appraised with a predetermined scaling as shown in FIG. 16 if a street value display residential map button 60 is pressed, displays employed locations superimposed on a residential map if a public assessment and the like and case location diagram button 61 is pressed, and displays an aerial photograph of the area to be appraised with a predetermined scaling if an aerial photograph button 62 is pressed, respectively.

According to this procedure, as only the land value information that the user feels appropriate as a land value information to calculate the land value are used for the calculation, inappropriate land value information can be excluded, and the reliability of land value calculation will improve.

Note that land value calculated as above is a standard land value, that is a land value benchmark, and not an individual land value of the location to be appraised. It is risky for a non-expert or a machine to perform an individual land value calculation due to its strong individuality. Therefore, the scope of this system does not exceed beyond an output of a land value benchmark appraisal table shown in FIG. 14 and FIG. 16. However, this system provides a self-appraisal program for allowing each user to perform a final appraisal at his/her own risk.

In other words, if a self-appraisal button 54 is pressed in a screen shown in FIG. 13, the self-appraisal program shown in FIG. 4 and FIG. 5 is transmitted to the user's terminal. In this program, fields indicated with black circles are filled with the aforesaid calculation result transferred, and, if the user fills other fields based on the individuality of each real estate, the value of the real estate at issue will be automatically calculated by the spreadsheet functions of this program.

According to this configuration, a final appraisal for highly individual real estate can be performed outside of this system by the user at his/her own risk. Thus, there is provided an effect to maintain the objectivity of a service using this system.

Incidentally, it is to be understood that the foregoing description is no more than one embodiment of the present invention, and that various changes and modifications can be made, without departing from the scope and spirit of the present invention.

For example, although the above embodiment is to provide the user with a service using the Internet, this service may be further materialized on a computer system connected with an intra-company LAN, or a stand-alone computer system. Also, of the aforesaid each component is not limited to being run on a server, and its part or entirety can be executed on the user's terminal.

According to the configuration described above, it is possible to provide a real estate appraisal auxiliary system and the like which can provide highly reliable appraisal services.

What is claimed is:

1. A real estate appraisal auxiliary system, comprising:
a map database storing means for storing a map database comprised by relating land value information and urban planning drawing information on a plurality of locations with their position coordinates on a map;
a use zoning obtaining means for obtaining the use zoning of a location to be appraised from the urban planning drawing information if the location to be appraised has been specified on a map;
a land value information retrieving means for retrieving land value information comparable with the location to be appraised based on the use zoning obtained by the use zoning obtaining means; and
a standard land value calculation means for calculating a standard land value for the location to be appraised based on the land value information retrieved by the land value information retrieving means.

2. The system according to claim 1, wherein
the system further comprises a publicly-assessed street facing land value obtaining means for obtaining, based on the location to be appraised specified by a user, the publicly-assessed street facing land value of the street to which the location at issue is adjacent, and
the land value information retrieving means retrieves, in reference to the publicly-assessed street facing land value, only the land value information which differs from the publicly-assessed street facing land value is within a predetermined range.

3. The system according to claim 1, wherein
the land value information retrieving means retrieves only the land value information within a predetermined range in reference to the location to be appraised.

4. The system according to claim 3, wherein
the land value information retrieving means retrieves the land value information within a wider range than the predetermined range in reference to the location to be appraised if the number of locations with land value information obtained from the predetermined range is less than or equal to a predetermined number.

5. The system according to claim 1, wherein
the land value information retrieving means searches land value information for a plurality of use zonings to be searched including the use zoning obtained by the use zoning obtaining means, and retrieves the land value information that is associated with respective use zonings.

6. The system according to claim 5, wherein
the land value information retrieving means displays the retrieved land value information according to use zoning.

7. The system according to claim 5, wherein
the land value information retrieving means displays only the land value information obtained by the use zoning obtaining means if the number of locations with land value information retrieved is greater than or equal to a predetermined number.

8. The system according to claim 1, wherein
the standard land value calculation means calculates a standard land value for the location to be appraised by using land value information selected by the user from the land value information retrieved by the land value information retrieving means.

9. The system according to claim 1, wherein
the system further comprises a calculation means transmission means for transferring the standard land value calculated by the standard land value calculation means and information on the location to be appraised, and transmitting to the user a calculation means for the user to enter individual information to thereby calculate the value of the real estate at issue.

10. A storage medium with a computer software program stored therein for use by a computer system to assist in appraising real estate, the software program comprising:
a map database storing means for storing a map database comprised by relating land value information and urban planning drawing information on a plurality of locations with their position coordinates on a map;
a use zoning obtaining means for obtaining the use zoning of a location to be appraised from the urban planning drawing information if the location to be appraised has been specified on a map;
a land value information retrieving means for retrieving land value information comparable with the location to be appraised based on the use zoning obtained by the use zoning obtaining means; and
a standard land value calculation means for calculating a standard land value for the location to be appraised based on the land value information retrieved by the land value information retrieving means.

11. The storage medium according to claim 10, wherein
the storage medium further comprises a publicly-assessed street facing land value obtaining means for obtaining, based on the location to be appraised specified by a user, the publicly-assessed street facing land value of the street to which the location at issue is adjacent, and
the land value information retrieving means retrieves, in reference to the publicly-assessed street facing land value, only the land value information which differs from the publicly-assessed street facing land value is within a predetermined range.

12. The storage medium according to claim 11, wherein
the land value information retrieving means retrieves only the land value information within a predetermined range in reference to the location to be appraised.

13. The storage medium according to claim 12, wherein
the land value information retrieving means retrieves the land value information within a wider range than the predetermined range in reference to the location to be appraised if the number of locations with land value information obtained from the predetermined range is less than or equal to a predetermined number.

14. The storage medium according to claim 10, wherein
the land value information retrieving means searches land value information for a plurality of use zonings to be searched including the use zoning obtained by the use zoning obtaining means, and retrieves the land value information that is associated with respective use zonings.

15. The storage medium according to claim 14, wherein
the land value information retrieving means displays the retrieved land value information according to use zoning.

16. The storage medium according to claim 14, wherein
the land value information retrieving means displays only the land value information obtained by the use zoning obtaining means if the number of locations with land value information retrieved is greater than or equal to a predetermined number.

17. The storage medium according to claim 10, wherein
the standard land value calculation means calculates a standard land value for the location to be appraised by using land value information selected by the user from the land value information retrieved by the land value information retrieving means.

18. The storage medium according to claim 10, wherein
the storage medium further comprises a calculation means transmission means for transferring the standard land value calculated by the standard land value calculation means and information on the location to be appraised, and transmitting to the user a calculation means for the user to enter individual information to thereby calculate the value of the real estate at issue.

19. A real estate appraisal auxiliary method, comprising the steps of:
obtaining the use zoning of a location to be appraised from the urban planning drawing information if the location to be appraised has been specified on a map database comprised by relating land value information and urban planning drawing information on a plurality of locations with their position coordinates on a map;
retrieving land value information comparable with the location to be appraised based on the use zoning obtained by the step of obtaining the use zoning; and
calculating a standard land value for the location to be appraised based on the land value information retrieved by the step of retrieving land value information.

20. The method according to claim 19, wherein
the method further comprises the step of obtaining, based on the location to be appraised specified by the user, the publicly-assessed street facing land value of the street to which the location at issue is adjacent, and
the step of retrieving land value information retrieves, in reference to the publicly-assessed street facing land value, only the land value information which differs from the publicly-assessed street facing land value is within a predetermined range.

21. The method according to claim 19, wherein
the step of retrieving land value information retrieves only the land value information within a predetermined range in reference to the location to be appraised.

22. The method according to claim 20, wherein
the step of retrieving land value information retrieves the land value information within a wider range than the predetermined range in reference to the location to be appraised if the number of locations with land value information obtained from the predetermined range is less than or equal to a predetermined number.

23. The method according to claim 19, wherein
the step of retrieving land value information searches land value information for a plurality of use zonings to be searched including the use zoning obtained by the step of obtaining the use zoning, and retrieves the land value information that is associated with respective use zonings.

24. The method according to claim 23, wherein
the step of retrieving land value information displays the retrieved land value information according to use zoning.

25. The method according to claim 23, wherein
the step of retrieving land value information displays only the land value information obtained by the step of obtaining the use zoning if the number of locations with land value information retrieved is greater than or equal to a predetermined number.

26. The method according to claim 19, wherein
the step of calculating a standard land value calculates a standard land value for the location to be appraised by using land value information selected by the user from the land value information retrieved by the step of retrieving land value information.

27. The method according to claim 19, wherein
the system further comprises the steps of transferring the standard land value calculated by the step of calculating a standard land value and information on the location to be appraised, and
transmitting to the user a calculation means for the user to enter individual information to thereby calculate the value of the real estate at issue.

28. A medium to which the standard land value obtained according to claim 1, claim 10 and claim 19 and information on the location to be appraised, and for maintaining a calculation program for the user to enter individual information to thereby calculate the value of the real estate at issue.
